(19) United States
(12) Patent Application Publication
(10) Pub. No.: US 2011/0199681 A1
(43) Pub. Date: Aug. 18, 2011

(54) DISPLAY DEVICE

(75) Inventors: Tomio YAGUCHI, Sagamihara (JP); Yasushi Nakano, Tokyo (JP); Shoichi Uchino, Annaka (JP); Tetsuya Nagata, Mobara (JP)

(73) Assignee: Hitachi Displays, Ltd.

(21) Appl. No.: 13/025,287

(22) Filed: Feb. 11, 2011

(30) Foreign Application Priority Data
Feb. 15, 2010 (JP) 2010-029704

(51) Int. Cl. G02B 5/30; G02F 1/00; G02F 1/1333; B32B 7/04

(52) U.S. Cl. 359/488.01; 428/188; 428/137; 428/139

(57) ABSTRACT

The present invention provides a display device having no less flexibility even in the case where a plate, such as a polarizing plate, is provided to the display cell with the distortion of the image being controllable, and the display device has a display cell DC on which an image can be displayed and a plate (PP1, 2) pasted to at least one side of the above described display cell, wherein the adhesiveness of the display cell to the plate in the direction perpendicular to the surface of the display cell that faces the plate is greater than the adhesiveness in the direction parallel to the facing surface.

The present application claims priority over Japanese Application JP2010-029704 filed on Feb. 15, 2010, the contents of which are hereby incorporated into this application by reference.

### BACKGROUND OF THE INVENTION

(1) Field of the Invention

The present invention relates to a display device, and in particular to a display device where a plate, for example a polarizing plate, is provided on at least one side of the display cell, for example a liquid crystal display device or an organic electroluminescence display device (organic EL display device).

(2) Description of the Related Art

Display devices having a display cell in plate form that can display an image, for example liquid crystal display devices and organic EL display devices using organic light emitting diodes (OLED's), have been developed and are available on the market. Such display devices are used in mobile electronics, such as portable phones and portable information terminals. Therefore, display devices have been required to be thinner, lighter and more flexible.

In order to make display devices thinner, lighter and more flexible, plastic substrates and thin glass substrates are used to form the display cell. In addition, a flexible display device is being developed so that it can be provided by forming a thin film transistors (TFT's) on a glass substrate, which is then removed or converted to a thin film, and pasting the thin film transistors on a plastic substrate.

However, polarizing plates are pasted on both sides of the display cell (liquid crystal panel), which may be flexible, in liquid crystal display devices, and a circular polarizing plate is pasted on the surface of the display cell (organic EL panel) in organic EL display devices. Polarizing plates are formed of a resin plate, which is as thick as approximately 100 μm, and thus has approximately the same, or a greater, thickness than the display cell that may be flexible. Furthermore, the bending strength is approximately the same as that of the thin glass substrate or plastic substrate. As a result, a great deal of the flexibility of the display device is lost when a polarizing plate is pasted on the display cell using an adhesive.

JP1999-337927A discloses a liquid crystal display panel where a polarizing plate is sandwiched between the frame and the display cell or backlight unit so as to be fixed, and thus the display cell can be prevented from changing in shape due to contraction and expansion of the polarizing plate, and excellent visibility can be secured at high temperatures and humidity.

However, the center portion of the polarizing plates made up of a polarizer and a protective material, particularly the upper polarizing plate (polarizing plate facing the front on the side opposite to the backlight unit) cannot be pressed to secure the visibility of the image, and thus the center portion of the polarizing plate cannot be fixed to the main surface of the display cell. Only the periphery of the polarizing plate is fixed to the main surface of the display cell by the frame. Therefore, the polarizing plate lifts in the center portion of the display cell when the polarizing plate expands due to high temperature and humidity, and there is a risk of the display being inconsistent. In addition, there is a layer of air between the polarizing plate and the display cell, which may cause the displayed image to be distorted, due to the difference in reflectance between the air layer and the material of the substrate that forms the display cell.

In addition, JP2005-70094A and JP2009-20168A disclose a method for suppressing inconsistency in the display normally caused by thermal deformation of the polarizing plate by creating a region having no adhesive layer for fixing the polarizing plate or fixing only part of the polarizing plate. In JP2005-70094A, however, the polarizing plate is fixed to the substrate along the four sides using an adhesive in a structure having a region where there is no adhesive layer, and therefore the force of the polarizing plate applied to substrate that forms the display cell prevents the display cell from changing in form, and thus loss of flexibility cannot be avoided in the display cell. In Patent Document JP2009-20168A, the flexibility of the display device is lost in the fixed portions. Furthermore, both in JP2005-70094 and JP2009-20168A, there is a layer of air where there is no adhesive, which causes the displayed image to be distorted, as in JP1999-337927A.

### SUMMARY OF THE INVENTION

An object of the present invention is to solve the above described problems and to provide a display device having no less flexibility with the distortion of the image being controllable, even in the case where a plate (member in sheet form), such as a polarizing plate, is provided to the flexible display cell.

In order to solve the above described problems, the display device according to the present invention has the following characteristics.

(1) A display device having a display cell on which an image can be displayed and a plate pasted to at least one side of the above described display cell is characterized in that an adhesiveness of the display cell to the plate in a direction perpendicular to a surface of the display cell that faces the plate is greater than an adhesiveness in a direction parallel to the surface.

(2) The display device according to the above (1) is characterized in that a liquid is intervened between the display cell and the plate.

(3) The display device according to the above (2) is characterized in that the liquid is a viscous fluid, has surface energy that is lower than the surface energy of the display cell and the surface energy of the plate, and has a boiling point of 200° C. or higher.

(4) The display device according to the above (2) or (3) is characterized in that the display cell has a substrate and the difference in the index of refraction between the liquid and the substrate is 0.2 or less.

(5) The display device according to any of the above (2) to (4) is characterized in that a main component of the liquid is a phthalate-based material or benzyl benzoate.

(6) The display device according to any of the above (1) to (5) is characterized in that the plate is a polarizing plate.

(7) The display device according to any of the above (1) to (6) is characterized in that the display cell has a substrate and the substrate is a plastic substrate.

(8) The display device according to any of the above (1) to (6) is characterized in that the display cell has a substrate and the substrate is a glass substrate having a thickness of 100 μm or less.

(9) The display device according to the above (8) is characterized in that the substrate has a thickness of 50 μm or less.

(10) The display device according to any of the above (1) to (9) is characterized by having a support member that makes contact with the plate through at least two points.

(11) The display device according to the above (10) is characterized in that the support member is a frame from which the center portion of the plate is exposed and which covers the peripheral portion of the plate and has two or more protrusions that make contact with the plate.

According to the present invention, such a structure that the adhesiveness of the display cell to the plate is greater in the direction parallel to the surface of the display cell that faces the plate than in the direction parallel to the surface is provided, and as a result, a highly flexible display device can be provided without any loss of flexibility due to the display cell.

In addition, when a liquid is intervened between the display cell and the plate, it becomes easy to provide such a structure where the adhesiveness in the direction perpendicular to the above described surface is greater than the adhesiveness in the direction parallel to the surface. Furthermore, when a viscous fluid is used as the liquid which has a surface energy that is lower than that of the display cell and the plate and has a boiling point of 200° C. or higher, the state of adhesion between the display cell and the plate is stabilized, and the liquid can be uniformly applied during the manufacture of the display device, and in addition, no problems arise when the display device is used, such as bubbles being generated in the liquid. In addition, when the difference in the index of refraction between the liquid and the material of the substrate that forms the display cell and makes contact with the liquid is 0.2 or less, it is possible to prevent the image from being distorted.

Furthermore, when a support member that makes contact with the plate through at least two points is provided, it is possible to prevent the plate from shifting in the direction parallel to the above described surface (rotating or translating). Moreover, when a frame that covers the periphery portion of the plate is used as this support member, the number of necessary parts can be prevented from increasing.

### BRIEF DESCRIPTION OF THE DRAWINGS

FIG. 1 is a cross sectional diagram showing the structure where the display cell and the plate are pasted together in the display device according to the present invention;

FIG. 2 is a perspective diagram showing an example of the configuration of the members of the display device; and

FIG. 3 is a perspective diagram showing the structure for preventing the plate from shifting by using a frame.

### DESCRIPTION OF THE EMBODIMENTS

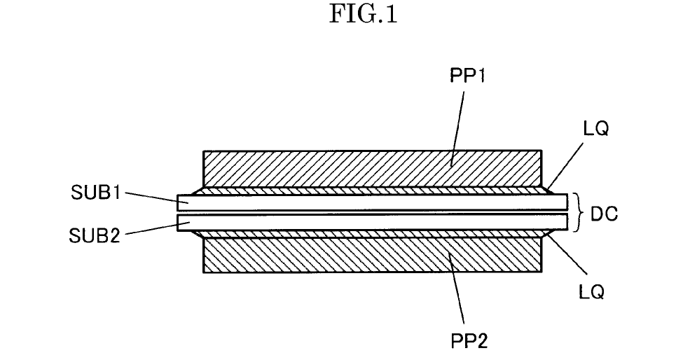

The display device according to the present invention is described in detail below in reference to FIGS. 1 to 3.

As shown in FIG. 1, the display device according to the present invention has a display cell DC on which an image can be displayed and plates (PP1, PP2) provided on the sides of the display cell DC, and is characterized in that the adhesiveness between the display cell DC and the plates (PP1, PP2) is greater in the direction perpendicular to the surface of the display cell that faces the plate than in the direction parallel to the surface.

Such a method for providing an extreme anisotropy to the adhesiveness can be achieved by pasting the substrates and the plates together to form a display cell using the surface tension of a liquid. When the display cell DC and the plates (PP1, PP2) are pasted together with the liquid LQ, there is adhesiveness between the substrates (SUB1, SUB2) and the plates (PP1, PP2) in the direction perpendicular to the interfaces due to the surface tension of the liquid. However, the volume and the surface area of the liquid do not change in the direction parallel to the interfaces, and therefore, there is only adhesiveness due to viscosity. Since the viscosity of the liquid is the cause of adhesiveness, it is difficult to secure adhesiveness for securing the plate in a certain location on the surface of the display cell when a nonviscous liquid is used.

In order for the material of the substrates that form the display cell and plates, such as polarizing plates or protective plates, to be pasted together with the liquid LQ, it is necessary for the liquid LQ to have the following properties.

(1) Being a viscous fluid.
(2) Having surface energy that is lower than that of the material of the substrates that form the display cell and the plates.
(3) Having a high boiling point. (Since conventional display devices are used at a temperature of 100° C. or less, the boiling point should be 200° C. or higher.)

Though the viscosity of the liquid, as in the above (1), causes the adhesiveness, nonviscous liquids cannot secure adhesiveness for securing a plate in a certain location on the surface of the display cell.

In addition, it is necessary to cover the entire region through which the facing two surfaces overlap with the liquid in order to paste the substrates and plates in the display cell together. Thus, it is necessary for the surfaces of both the substrates and the plates to have affinity for the liquid. In other words, the liquid needs to have surface energy that is lower than that of both the substrates and the plates, as in the above (2).

In order for an image to be displayed, the display cell and the plates must be joined together, and the liquid relating to the adhesion must not evaporate. Thus, the liquid must not evaporate when the display device is used in a normal environment. Liquid crystal display devices are not usually used at a temperature of 100° C. or higher, and therefore, the liquid may have a boiling point at this temperature or higher, but it is necessary for the boiling point of the liquid to be 200° C. or higher, as in the above (3), taking changes over time and reliability into consideration.

Furthermore, in the case where the difference in the index of refraction between the liquid and the surface of the substrates and the plates, such as polarizing plates, in the adjacent display cell is great, it causes light to reflect and the transmittance of light to lower. Therefore, it is desirable to make the difference in the index of refraction between the liquid and these materials as small as possible. Most members selected to form the liquid crystal display device have an index of refraction of approximately 1.5+/−0.2 in relation to the glass substrates. According to the present invention, it is assumed that the display device may use plastic substrates instead of glass substrates in order to provide the flexibility to the display cell, and therefore, it is desirable to use a liquid of which the index of refraction is different from the index of refraction of the material of the substrates that form the display cell by +/−0.2.

Examples of the liquid that meet the requirements are phthalate-based liquids and benzyl benzoate. In the display device according to the present invention, these liquids can be used as a main component or it is possible to mix these liquids with other liquids for use if necessary.

The plates (PP1, PP2) used in the display device according to the present invention can be polarizing plates or protective plates for protecting the display cell.

In addition, as for the material of the substrates that form the display cell (SUB1, SUB2), glass plates, particularly flexible glass plates that are as thin as 100 μm or less, desirably 50 μm or less, and plastic plates are appropriate for use. Here, FIG. 1 shows two substrates (SUB1, SUB2) that face each other and form the liquid crystal display cell where liquid crystal, not shown, is provided between the two substrates, and furthermore, electrodes, thin film transistors for driving the electrodes, wires, color filters and other necessary parts are formed on the respective substrates.

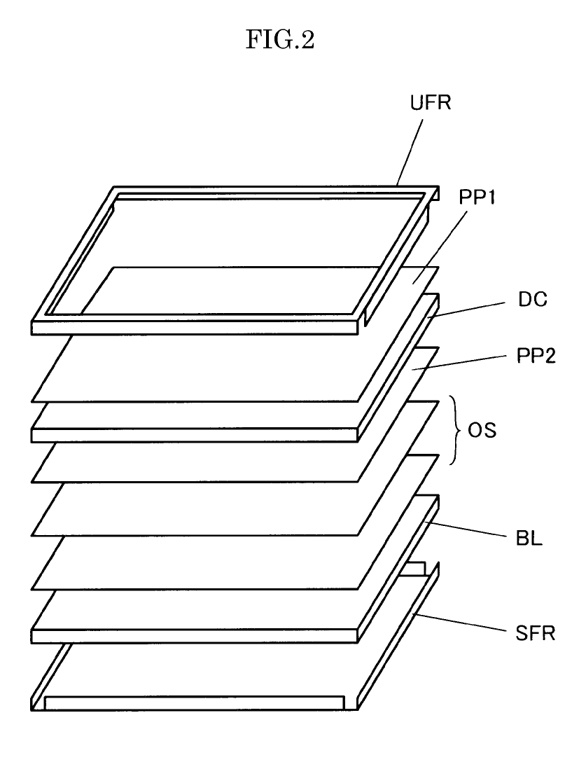

FIG. 2 is a perspective diagram showing the configuration of the members of the liquid crystal display device, which is one example of the display device according to the present invention. Polarizing plates (PP1, PP2) are pasted to the two sides of the display cell DC as the plates with a liquid, not shown. Optical sheets OS, such as a diffusion sheet and a prism sheet, and a backlight BL formed of a light source, such as of light emitting diodes and a light guiding plate, are provided on the bottom side and assembled with the display cell DC using a lower frame SFR and an upper frame UFR. The upper frame covers the peripheral portion of the polarizing plate PP1 and the display cell DC but does not prevent the image from being displayed.

In the display device according to the present invention, the display cell DC and the plates (PP1, PP2), such as polarizing plates, are pasted together using a liquid, and therefore, the adhesiveness in the direction parallel to the interfaces is quite low. Therefore, a structure for preventing the plates from shifting, such as rotating or translating, is necessary. Such a structure may be provided with a support member that makes contact with each plate through at least two points in order to secure the plate so that it does not rotate or move. The points through which the support members make contact with the plate may be on the surface of the plate or on the sides of the plate.

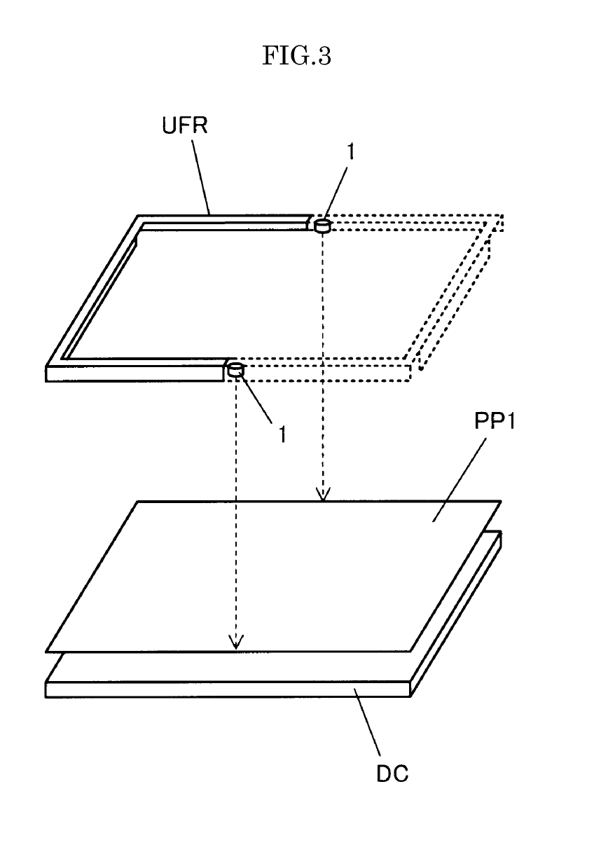

FIG. 3 shows as an example of a support member a structure for preventing the plate PP1 from shifting by using a frame, which is the upper frame UFR. Two or more protrusions 1 are provided to the frame UFR, from which the center portion of the plate PP1 is exposed and which covers the periphery portion, so that the protrusions 1 press the plate PP1 against the display cell DC within the region that does not relate to the image display in the structure. Here, the protrusions 1 may be formed so as to make contact with the sides of the plate PP1 and the display cell DC.

Since a more flexible display element (combination of a display cell and polarizing plates) can be gained, the present invention can provide a more flexible display device. In the case where a display element having thicker glass substrates is used, though an outer case having high rigidity must be formed in order to prevent the display element from changing form according to the prior art, high flexibility of the display element makes it difficult for the display device to be broken when a slight force is applied to change the form, and therefore, a simpler outer case having low rigidity can be used for securing the display device, and thus, the display device can be formed at a low cost according to the present invention.

As described above, the present invention can provide a no less flexible display device with the distortion of the image being controllable even in the case where a plate, such as a polarizing plate, is provided to the display cell.

What is claimed is:

1. A display device, comprising a display cell on which an image can be displayed and a plate pasted to at least one side of said display cell, characterized in that
an adhesiveness of the display cell to the plate in a direction perpendicular to a surface of the display cell that faces the plate is greater than an adhesiveness in a direction parallel to the surface.

2. The display device according to claim 1, characterized in that a liquid is intervened between the display cell and the plate.

3. The display device according to claim 2, characterized in that the liquid is a viscous fluid, has surface energy that is lower than the surface energy of the display cell and the surface energy of the plate, and has a boiling point of 200° C. or higher.

4. The display device according to claim 2, characterized in that the display cell has a substrate and the difference in the index of refraction between the liquid and the substrate is 0.2 or less.

5. The display device according to claim 3, characterized in that the display cell has a substrate and the difference in the index of refraction between the liquid and the substrate is 0.2 or less.

6. The display device according to claim 2, characterized in that a main component of the liquid is a phthalate-based material or benzyl benzoate.

7. The display device according to claim 3, characterized in that a main component of the liquid is a phthalate-based material or benzyl benzoate.

8. The display device according to claim 1, characterized in that the plate is a polarizing plate.

9. The display device according to claim 2, characterized in that the plate is a polarizing plate.

10. The display device according to claim 1, characterized in that the display cell has a substrate and the substrate is a plastic substrate.

11. The display device according to claim 2, characterized in that the display cell has a substrate and the substrate is a plastic substrate.

12. The display device according to claim 1, characterized in that the display cell has a substrate and the substrate is a glass substrate having a thickness of 100 μm or less.

13. The display device according to claim 2, characterized in that the display cell has a substrate and the substrate is a glass substrate having a thickness of 100 μm or less.

14. The display device according to claim 13, characterized in that the substrate has a thickness of 50 μm or less.

15. The display device according to claim 1, characterized by having a support member that makes contact with the plate through at least two points.

16. The display device according to claim 2, characterized by having a support member that makes contact with the plate through at least two points.

17. The display device according to claim 16, characterized in that the support member is a frame from which the center portion of the plate is exposed and which covers the peripheral portion of the plate and has two or more protrusions that make contact with the plate.

18. The display device according to claim 3, characterized in that
the plate is a polarizing plate,
the display device has a support member which makes contact with the polarizing plate through at least two points, and
the support member is a frame from which the center portion of the plate is exposed and which covers the peripheral portion of the plate and has two or more protrusions which make contact with the plate.

19. The display device according to claim 18, characterized in that the display cell has a substrate and the difference in the index of refraction between the liquid and the substrate is 0.2 or less.

20. The display device according to claim 18, characterized in that a main component of the liquid is a phthalate-based material or benzyl benzoate.
